(19) United States
(12) Patent Application Publication
(10) Pub. No.: US 2015/0073847 A1
(43) Pub. Date: Mar. 12, 2015

(54) DISPATCH VOIP SYSTEM

(71) Applicant: Pedro Gonzalez, Jackson Heights, NY (US)

(72) Inventor: Pedro Gonzalez, Jackson Heights, NY (US)

(21) Appl. No.: 14/025,604

(22) Filed: Sep. 12, 2013

(51) Int. Cl. G06Q 50/30; H04M 7/00; G06Q 10/10

(52) U.S. Cl. CPC G06Q 50/30; G06Q 10/10; H04M 7/006
USPC 705/7.15

(57) ABSTRACT

A dispatch VOIP system is disclosed. The dispatch VOIP system includes a VOIP server system with a VOIP system, a processor system, a communications interface, a communications system, an input system and an output system and a GPS system residing on the VOIP server system, the GPS system allows a dispatcher user to track one or more second users without distance limitation. The dispatch VOIP system establishes a two-way communication system between one or more for hires and one or more dispatchers. The dispatch VOIP system may also be a for hire dispatch VOIP system for one or more for hire driver users or one or more taxi cab driver users.

This application claims priority to U.S. Provisional Application 61/700,130 filed on Sep. 12, 2012, the entire disclosure of which is incorporated by reference.

### BACKGROUND OF THE INVENTION

1. Field of the Invention

The present invention is a voice over Internet protocol system or VOIP system. More specifically, the present invention is a dispatch VOIP system.

2. Description of the Related Art

Voice over Internet protocol systems or VOIP systems are efficient communications systems that may be applied to many industries and situations. A VOIP system may solve many problems in a dispatch system.

### BRIEF SUMMARY OF THE INVENTION

The present invention is a voice over Internet protocol system or VOIP system. More specifically, the present invention is a dispatch VOIP system.

The dispatch VOIP system includes a VOIP server system with a VOIP system, a processor system, a communications interface, a communications system, an input system and an output system, the VOIP server system having access to a communications network and a memory system with an operating system, a communications module, a web browser module, a web server application and a dispatch VOIP system non-transitory storage media. The dispatch VOIP system includes a website with a plurality of web pages to measure and monitor the dispatch VOIP system and a GPS system residing on the VOIP server system, the GPS system allows a dispatcher user to track one or more second users.

The dispatch VOIP system may be a for hire dispatch VOIP system that includes a VOIP server system with a VOIP system, a processor system, a communications interface, a communications system, an input system and an output system, the VOIP server system having access to a communications network and a memory system with an operating system, a communications module, a web browser module, a web server application and a for hire dispatch VOIP system non-transitory storage media. The dispatch VOIP system also includes a website with a plurality of web pages to measure and monitor the for hire dispatch VOIP system and a GPS system allowing a dispatcher user to track one or more for hire driver users.

It is an object of the present invention to provide a dispatch VOIP system between one or more for hires and one or more dispatchers resulting in better service to for hire customers. It is an object of the present invention to provide a dispatch VOIP system that utilizes a global positioning system or GPS and an Internet connection.

It is an object of the present invention to provide a VOIP system that is without distance limitation.

It is an object of the present invention to provide a VOIP system that establishes a two-way communication system between one or more for hires and one or more dispatchers.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a dispatch VOIP system, in accordance with one embodiment of the present invention.

FIG. 2A illustrates a block diagram of a VOIP server system, in accordance with one embodiment of the present invention.

FIG. 2B illustrates a block diagram of a client computer, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

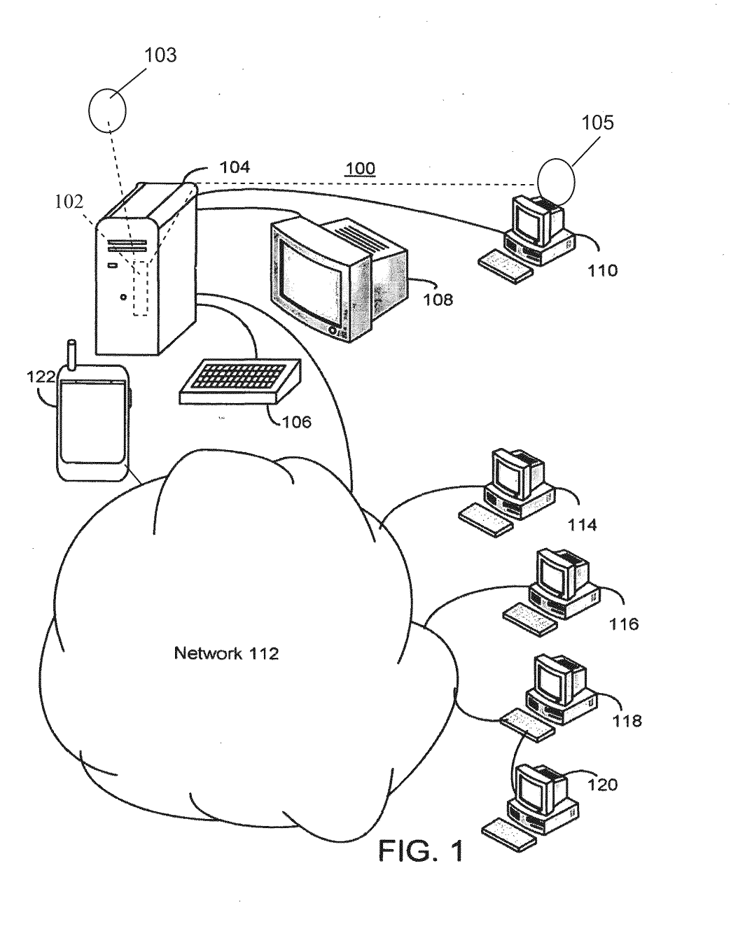

FIG. 1 illustrates a system overview of a dispatch VOIP system, in accordance with one embodiment of the present invention. The dispatch VOIP system 100 includes a VOIP system 102, a VOIP server system 104, an input system 106, an output system 108, a plurality of client systems 110, 114, 116, 118 and 120, a communications network 112 and a hand-held device 122. In other embodiments, the dispatch VOIP system 100 may include additional components and/or may not include all of the components listed above.

The VOIP system 102 includes a dispatcher microphone and speaker 103 and one or more for hire cab driver user microphone and speakers 105 to allow two-way voice communication between the dispatcher user and the one or more for hire cab driver users.

The VOIP server system 104 may include one or more servers. One server 104 may be the property of the distributor of any related software. In other embodiments, the dispatch VOIP system 100 may include additional components and/or may not include all of the components listed above.

The input system 106 may be used for entering input into the VOIP server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (e.g., IrDA, USB), for example.

The output system 108 may be used for receiving output from the VOIP server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The dispatch VOIP system 100 illustrates some of the variations of the manners of connecting to the VOIP server system 104, which may be an information providing website. The VOIP server system 104 may be directly connected and/or wirelessly connected to the plurality of client systems 110, 114, 116, 118 and 120 and are connected via the communications network 112. Client systems 120 may be connected to the VOIP server system 104 via the client system 118. The communications network 112 may be any one of, or any combination of, one or more local area networks or LANs, wide area networks or

WANs, wireless networks, telephone networks, the Internet and/or other networks. The communications network 112 may include one or more wireless portals. The client systems 110, 114, 116, 118 and 120 are any system that an end user may use to access the VOIP server system 104. For example, the client systems 110, 114, 116, 118 and 120 may be personal computers, workstations, laptop computers, game consoles, handheld network enabled audio/video players and/or any other network appliance.

The client system 120 accesses the VOIP server system 104 via the combination of the communications network 112 and another system, which in this example is client system 118. The client system 120 is an example of a handheld wireless device 122, such as a mobile phone or a handheld network enabled audio/music player, which may also be used for accessing network content.

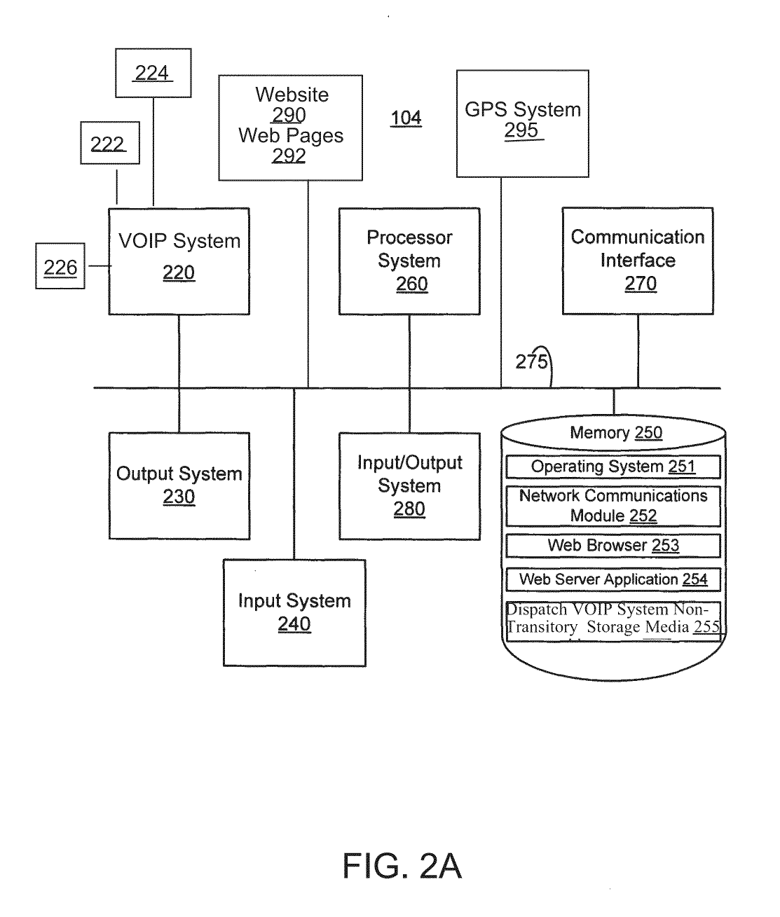

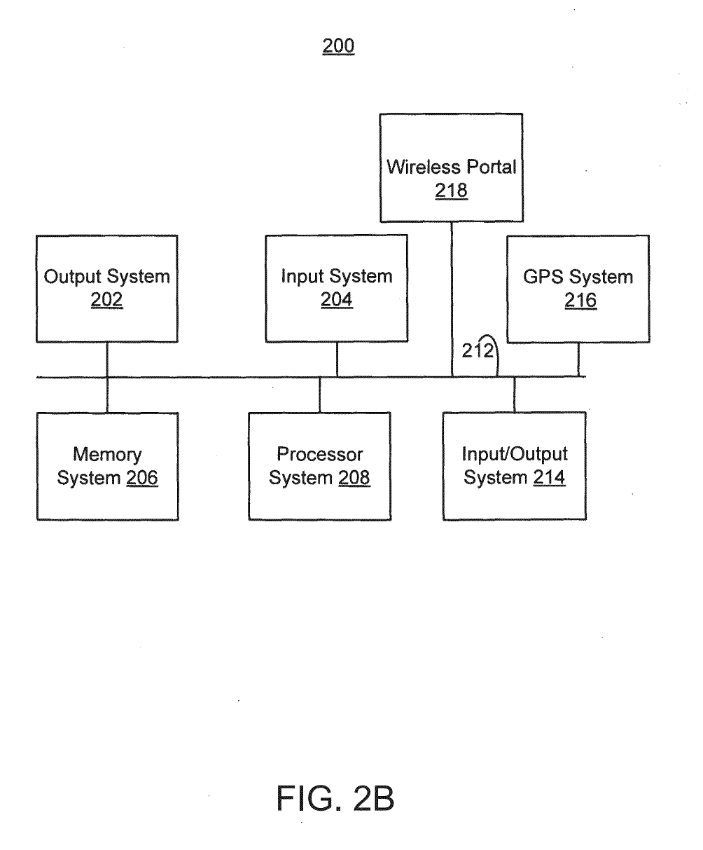

FIG. 2A illustrates a block diagram of a VOIP server system, in accordance with one embodiment of the present invention. The VOIP server system 104 may include a VOIP system 220, an output system 230, an input system 240, a memory system 250, which may store an operating system 251, a communications module 252, a web browser module 253, a web server application 254 and a dispatch VOIP system non-transitory storage media 255. The VOIP server system 104 may also include a processor system 260, a communications interface 270, a communications system 275 and an input/output system 280. The VOIP server system 104 may include a website 290 with a plurality of webpages 292 to measure and monitor the dispatch VOIP system 100. The VOIP server system 104 may also include a global positioning system or GPS system 295 residing on the VOIP server system 104. The GPS system 295 allows a dispatcher user to track one or more second users. In other embodiments, the VOIP server system 104 may include additional components and/or may not include all of the components listed above.

The VOIP system 220 includes a dispatcher microphone and speaker 222 and one or more taxi cab driver user microphone and speakers 224 to allow two-way voice communication between the dispatcher user and the one or more second users. The VOIP system 220 includes a voice amplifier 226 provided to the dispatcher microphone and speaker 222 and the one or more for hire driver users.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (e.g., IrDA, USB), for example.

The memory system 250 may include, for example, any one of, some of, any combination of, or all of a long term storage system, such as a hard drive; a short term storage system, such as random access memory; a removable storage system, such as a floppy drive or a removable drive and/or a flash memory. The memory system 250 may include one or more machine readable mediums that may store a variety of different types of information. The term machine readable medium is used to refer to any medium capable of carrying information that is readable by a machine. One example of a machine-readable medium is a computer-readable medium. The memory system 250 may store one or more machine instructions for measuring and monitoring the dispatch VOIP system. The operating system 251 controls all software and hardware of the dispatch VOIP system 100. The communications module 252 enables the VOIP server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the VOIP server system 104 to interface with the network 112. In this embodiment, the output system 230 sends communications to the communication interface 270. The communications system 275 communicatively links the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

FIG. 2B illustrates a block diagram of a client computer, in accordance with one embodiment of the present invention.

The client system 200 may include an output system 202, an input system 204, a memory system 206, a processor system 208, a communications system 212, an input/output system 214, a GPS system 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet, for example.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (e.g., Infrared Data Association or IrDA, Universal Serial Bus or USB), for example. The memory system 206 may include, for example, any one of, some of, any combination of or all of a long term storage system, such as a hard drive, a short term storage system, such as a random access memory; a removable storage system, such as a floppy drive or a removable drive, and/or a flash memory. The memory system 206 may include one or more machine readable mediums that may store a variety of different types of information. The term machine readable medium is used to refer to any medium that is structurally configured for carrying information in a format that is readable by a machine. One example of a machine-readable medium is a computer-readable medium. The memory system 206 also stores an application for measuring and monitoring a dispatch VOIP system.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively links the output system 202, the input system 204, the memory system 206, the processor system 208, and/or the input/output system 214 to each other. The communications system 212 may include any one of, some of, any combination of, or all of one or more electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional, and may be used in addition to or in place of the output system 202 and/or the input device 204.

The client systems 110, 114, 116, 118, 120 and the handheld wireless device 122 may also be tied into a GPS system 216 or a wireless portal 218 which is also tied directly into the communications system 212. Any GPS system 216 or wireless portal 218 would also include software and a website module (no number) to maintain, allow access to and run the website as well.

The dispatch VOIP system may include a VOIP server system with a VOIP system, a processor system, a communications interface, a communications system, an input system and an output system, the VOIP server system having access to a communications network and a memory system with an operating system, a communications module, a web browser module, a web server application and a dispatch VOIP system non-transitory storage media 255. The dispatch VOIP system may include a website with a plurality of web pages to measure and monitor the dispatch VOIP system and a GPS system residing on the VOIP server system, the GPS system allows a dispatcher user to track one or more second users.

The dispatch VOIP system may also include a client system, the client system may include an output system, an input system, a memory system, a processor system and a communications system. The client system may access the VOIP server system via the communications network that may be the Internet or other suitable communications network. The client system may be a computer, a tablet computer or other suitable communications network. The VOIP system may include a dispatcher microphone and speaker and one or more taxi cab driver user microphone and speakers to allow two-way voice communication between the dispatcher user and the one or more second users. The GPS system may track the one or more second users without distance limitation. The one or more second users may be one or more taxi cab driver users.

The dispatch VOIP system may also be a for hire dispatch VOIP system. The for hire dispatch VOIP system may include a VOIP server system with a VOIP system, a processor system, a communications interface, a communications system, an input system and an output system, the VOIP server system having access to a communications network. The for hire dispatch VOIP system may include a memory system with an operating system, a communications module, a web browser module, a web server application and a for hire dispatch VOIP system non-transitory storage media. The for hire dispatch VOIP system may include a website with a plurality of web pages to measure and monitor the for hire dispatch VOIP system and a GPS system allowing a dispatcher user to track one or more for hire driver users. The for hire dispatch VOIP system may further include a client system, the client system may include an output system, an input system, a memory system, a processor system and a communications system. The client system may access the VOIP server system via the communications network wherein the communications network may be the Internet. The client system may be a computer and a tablet computer. The VOIP system may include a voice amplifier provided to the dispatcher microphone and speaker and the one or more for hire driver users. The VOIP system may include a dispatcher microphone and speaker and one or more for hire driver user microphone and speakers to allow two-way voice communication between the dispatcher user and the one or more for hire driver users. The for hire dispatch VOIP system non-transitory storage media may monitor the one or more for hire driver users, logs-in when one or more for hire customer users request service from the one or more for hire driver users and accesses the one or more for hire driver users profile information. The GPS system may track the one or more for hire driver users without distance limitation. The one or more for hire driver users may be one or more taxi cab driver users.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A dispatch VOIP system, comprising:
a VOIP server system with a VOIP system, a processor system, a communications interface, a communications system, an input system and an output system, the VOIP server system having access to a communications network;
a memory system with an operating system, a communications module, a web browser module, a web server application and a dispatch VOIP system non-transitory storage media;
a website with a plurality of web pages to measure and monitor the dispatch VOIP system; and
a GPS system residing on the VOIP server system, the GPS system allows a dispatcher user to track one or more second users.

2. The dispatch VOIP system according to claim 1, further comprising a client system, the client system includes an output system, an input system, a memory system, a processor system and a communications system.

3. The dispatch VOIP system according to claim 2, wherein the client system accesses the VOIP server system via the communications network.

4. The dispatch VOIP system according to claim 3, wherein the communications network is the Internet.

5. The dispatch VOIP system according to claim 3, wherein the client system is a computer.

6. The dispatch VOIP system according to claim 3, wherein the client system is a tablet computer.

7. The dispatch VOIP system according to claim 1, wherein the VOIP system includes a dispatcher microphone and speaker and one or more taxi cab driver user microphone and speakers to allow two-way voice communication between the dispatcher user and the one or more second users.

8. The dispatch VOIP system according to claim 1, wherein the GPS system tracks the one or more second users without distance limitation.

9. The dispatch VOIP system according to claim 8, wherein the one or more second users are one or more taxi cab driver users.

10. A for hire dispatch VOIP system, comprising:
a VOIP server system with a VOIP system, a processor system, a communications interface, a communications system, an input system and an output system, the VOIP server system having access to a communications network;
a memory system with an operating system, a communications module, a web browser module, a web server application and a for hire dispatch VOIP system non-transitory storage media;
a website with a plurality of web pages to measure and monitor the for hire dispatch VOIP system; and
a GPS system allowing a dispatcher user to track one or more for hire driver users.

11. The for hire dispatch VOIP system according to claim 10, further comprising a client system, the client system includes an output system, an input system, a memory system, a processor system and a communications system.

12. The for hire dispatch VOIP system according to claim 11, wherein the client system accesses the VOIP server system via the communications network.

13. The for hire dispatch VOIP system according to claim 12, wherein the communications network is the Internet.

14. The for hire dispatch VOIP system according to claim 12, wherein the client system is a computer.

15. The for hire dispatch VOIP system according to claim 12, wherein the client system is a tablet computer.

16. The for hire dispatch VOIP system according to claim 10, wherein the VOIP system includes a voice amplifier provided to the dispatcher microphone and speaker and the one or more for hire driver users.

17. The for hire dispatch VOIP system according to claim 10, wherein the VOIP system includes a dispatcher microphone and speaker and one or more for hire driver user microphone and speakers to allow two-way voice communication between the dispatcher user and the one or more for hire driver users.

18. The for hire dispatch VOIP system according to claim 10, wherein the for hire dispatch VOIP system non-transitory storage media monitors the one or more for hire driver users, logs-in when one or more for hire customer users request service from the one or more for hire driver users and accesses the one or more for hire driver users profile information.

19. The for hire dispatch VOIP system according to claim 10, wherein the GPS system tracks the one or more for hire driver users without distance limitation.

20. The for hire dispatch VOIP system according to claim 10, wherein the one or more for hire driver users are one or more taxi cab driver users.
